(19) United States
(12) Patent Application Publication
(10) Pub. No.: US 2021/0370632 A1
(43) Pub. Date: Dec. 2, 2021

(54) DISCHARGE APPARATUS FOR DISCHARGING PELLETS FROM A ROTARY PRESS

(71) Applicant: Fette Compacting GmbH, Schwarzenbek (DE)

(72) Inventors: Stefan Luedemann, Hamburg (DE); Friedrich Meissner, Schwarzenbek (DE)

(73) Assignee: Fette Compacting GmbH, Schwarzenbek (DE)

(21) Appl. No.: 17/333,536

(22) Filed: May 28, 2021

(30) Foreign Application Priority Data
May 28, 2020 (DE) 10 2020 114 369.9

(51) Int. Cl. B30B 15/32; B30B 15/30

(52) U.S. Cl. CPC B30B 15/32; B30B 15/30

(57) ABSTRACT

A discharge apparatus for discharging pellets from a rotary press comprises an inlet channel configured to receive pellets from an ejection apparatus of the rotary press, a first discharge channel connected to the inlet channel, and a second discharge channel connected to the inlet channel. A gate is positioned between the inlet channel and the first and second discharge channels. The gate is configured to be shifted between a first position, in which pellets are directed from the inlet channel into the first discharge channel, and a second position, in which pellets are directed from the inlet channel into the second discharge channel. A pressure equalization channel configured to open into one of the first and second discharge channels and is configured to equalize a pressure between the inlet channel and at least one of the first and second discharge channels.

### CROSS REFERENCE TO RELATED INVENTION

This application is based upon and claims priority to, under relevant sections of 35 U.S.C. § 119, German Patent Application No. 10 2020 114 369.9, filed May 28, 2020, the entire contents of which are hereby incorporated by reference.

### TECHNICAL FIELD

The invention relates to a discharge apparatus for discharging pellets from a rotary press. The discharge apparatus comprises an inlet channel that can be connected to an ejection apparatus of the rotary press for pellets produced in the rotary press as well as a first discharge channel and a second discharge channel, further comprising a gate arranged between the inlet channel on one side and the first and second discharge channel on the other side, wherein the gate can be shifted between a first position, in which pellets are directed from the inlet channel into the first discharge channel, and a second position, in which pellets are directed from the inlet channel into the second discharge channel.

The invention also relates to a rotary press comprising a rotor, wherein the rotor comprises an upper and a lower punch guide for upper and lower press punches as well as a die plate between the punch guides. The press punches cooperate with receiving means of the die plate. The rotary press further comprises at least one filling apparatus in which material to be pressed is filled into the receiving means. At least one pressing apparatus that cooperates with the upper press punches and lower press punches during operation such that said punches press material located in the receiving means into pellets, and comprising an ejection apparatus for the pellets produced in the rotary press.

### BACKGROUND

Rotary presses comprise a rotor that is generally driven so as to rotate about a vertical axis and that has an upper and a lower punch guide for an upper and lower press punch and a die plate between the punch guides. The press punches rotate together with the die plate and are moved axially for example by means of control cams during their rotation. In addition to at least one filling apparatus, in which material to be pressed is filled into receiving means of the die plate, and a pressing apparatus, in which the material filled into the receiving means is pressed into pellets, in particular tablets, by means of the upper and lower press punches, rotary presses of this kind also comprise an ejection apparatus. Known ejection apparatuses often comprise a scraping apparatus for scraping pellets off the die plate, which pellets were typically previously conveyed onto the top side of the die plate by means of the lower punches being raised. In known rotary presses, the ejection apparatus is often upstream of a discharge apparatus for discharging the pellets from the rotary press. Discharge apparatuses of this kind comprise an inlet channel, into which the pellets scraped off the die plate by means of the scraping apparatus are directed. The discharge apparatus generally comprises a slope, such that the pellets are conveyed through said apparatus by the force of gravity. It is also known to arrange a gate that can be shifted between two positions in the discharge apparatus. Said gate directs pellets directed into the inlet channel into either the first discharge channel or the second discharge channel depending on its position. For example, one of the discharge channels may be a “good” channel for “good” tablets and the other of the discharge channels may be a “bad” channel for “bad” tablets. It is also conceivable, for example, for one of the discharge channels to be a sampling channel for sampling pellets to be subjected to random testing, for example. A discharge apparatus having a gate of this kind is known for example from DE 10 2007 015 672 B3. Here, the gate comprises a gate element that is mounted such that it can pivot about an axis.

Gates of this kind are generally actuated by specifying end positions that represent the two switching positions of the gate. If an end position is not reached, this can be detected by means of sensors and a corresponding error message can be issued. Known rotary presses generally have a housing that encloses the rotor and the discharge apparatus. There may be a pressure difference between the housing and the surroundings of the housing. In particular, the interior of the housing may be at a positive or negative pressure with respect to the discharge channels. This is in particular the case with so-called containment presses, in which the housing is sealed with respect to the surroundings in order to minimize the egress of dust from the interior of the housing into the surroundings.

It has been found that gates in rotary presses of this kind, especially, do not always reliably reach their specified end positions. This leads to malfunctions and thus to reduced machine availability, and therefore unmanned operation and thus production is only possible to a limited extent. For example, a gate malfunction can lead to pellets not being sampled in the desired manner. In the worst-case scenario, a gate malfunction can result in bad tablets entering the outlet for good tablets. The tablets then have to be thoroughly checked again by subjecting them to a 100% inspection and sorted in the outlet for good tablets, which is a laborious task. If this is not possible or practical, the tablets produced may have to be completely destroyed.

One attempt to solve this problem could consist in making the drives for moving the gates more powerful, in particular with a higher torque or using other types of drive, for example pneumatic drives, in order to generate higher torques in this manner. However, this produces other disadvantages. For example, more powerful gate drives could damage pellets trapped by the gate. Furthermore, malfunctions with regard to the gate reaching the end positions could still occur with more powerful gate drives. Finally, more powerful gate drives are associated with higher costs and higher energy consumption and require greater installation space, which is problematic in the case of smaller rotary presses. The higher power demand also results in a greater amount of heat being produced in the tablet flow, which is problematic in particular in the case of thermolabile pellets. In this regard, the high energy demand that potentially comes with more powerful gate drives for holding the gate in the relevant end position creates additional problems.

On the basis of the explained prior art, the object of the invention is to provide a discharge apparatus and a rotary press of the above-cited type by means of which reliable operation of the gate of the discharge apparatus is possible without the need for more powerful gate drives, especially also in the case of containment presses.

### BRIEF SUMMARY OF THE INVENTION

In an embodiment, a discharge apparatus comprises a pressure equalization channel provided in parallel with the gate, by means of which the pressure is equalized between the inlet channel on the one hand and the first and/or second discharge channel on the other.

The pellets produced in the rotary press may in particular be tablets. The rotary press may therefore be a rotary tablet press, in particular. The pellets produced in the rotary press enter the inlet channel of the discharge apparatus from the ejection apparatus of the rotary press, which inlet channel is connected to the ejection apparatus. The ejection apparatus may comprise a scraping apparatus for scraping pellets off the top side of the die plate of a rotor of the rotary press and into the inlet channel. As mentioned above, the discharge apparatus may comprise a slope, such that pellets directed into the inlet channel can be conveyed through the discharge apparatus by the force of gravity. The first discharge channel of the discharge apparatus may lead to a first outlet of the rotary press and the second discharge channel may lead to a second outlet of the rotary press. The first outlet of the rotary press may for example be an outlet for good pellets, in particular good tablets, i.e. for pellets identified as adequate by a sensor system. The second outlet may for example be an outlet for bad pellets, in particular bad tablets, i.e. for pellets identified as defective by a sensor system. However, it is also possible, for example, for one of the outlets to be an outlet for taking samples, i.e. for sampling pellets.

The invention is based on the knowledge that, during the movement of the gate between its positions, there can under certain circumstances be significant pressure differences and therefore the relevant end position may not be reached. The invention is also based on the knowledge that this is caused by the fact that the gate diverts the pellets and thus also the airflow from one discharge channel into the other discharge channel. This opening and closing of individual discharge channels creates a pressure difference across the gate. This applies, in particular, if the housing of a rotary press equipped with the discharge apparatus is subjected to a different pressure, in particular a positive or negative pressure, with respect to the surroundings or the discharge channels on account of suitable suction means, or if the housing is sealed with respect to the surroundings, as is the case with containment presses. The pressure difference across the gate results in a torque acting on the gate that, in unfavorable circumstances, may prevent the gate from reaching the desired end position. In containment systems, there are also cases in which peripheral equipment connected to the rotary press, such as dedusting devices or other peripheral equipment, comprise their own suction means. This can also create pressure differences across the gate depending on the setting of this suction means in relation to the suction means of the rotary press for generating a negative pressure inside the press.

In order to solve this problem, according to the invention, a pressure equalization channel is provided in parallel with the gate. By means of the pressure equalization channel, the pressure is equalized between the inlet channel on the one hand and the first and/or second discharge channel on the other, in particular when the gate is in the position that closes the relevant discharge channel. Depending on the gate position, the pressure may be equalized between the inlet channel and either one or both outlet channels. By means of the pressure equalization channel, the pressure difference across the gate is at least reduced. Complete pressure equalization may also occur, however this is frequently not required. Indeed, even partial pressure equalization and an associated corresponding reduction of the pressure difference is enough to ensure that the gate reliably reaches the end positions with conventional gate drives. Therefore, in the case of a smaller pressure difference, an accordingly smaller drive torque is sufficient for reliably switching the gate. The pressure equalization channel may be permanently open. As such, no pressure equalization valve or the like is required. Furthermore, since the discharge apparatus may also be located in a region that is closed off from the surroundings by means of a housing of the rotary press or that is at a positive or negative pressure, pressure equalization and an associated airflow inside the discharge apparatus or inside the housing of the rotary press is unproblematic with regard to maintaining the positive or negative pressure or maintaining the state of being closed off. It should also be noted that, although the gate generally does not completely seal the entrance to the relevant blocked discharge channel in the relevant end position, the airflow that is still possible over the gate in the relevant end position is not sufficient by itself to prevent a pressure difference that is detrimental to the end positions being reached, in particular to reduce said pressure difference sufficiently quickly when the gate is being moved. This problem is solved by means of the pressure equalization channel according to the invention in that same enables an airflow in parallel with the gate and thus significantly reduces the pressure difference across the gate. Any residual pressure difference is determined by the cross-section of the pressure equalization channel and the flow speed generated. The residual pressure difference can be reduced, as is desired, by correspondingly dimensioning the pressure equalization channel, such that the movement of the gate into the end positions is not hindered. The flow cross-section of the pressure equalization channel may accordingly be at least 10% of the flow cross-section of the inlet channel, preferably at least 25% of the flow cross-section of the inlet channel, more preferably at least 50% of the flow cross-section of the inlet channel, even more preferably at least 100% of the flow cross-section of the inlet channel.

By virtue of the invention, it is ensured that the end positions are reliably reached with typical drive torques for the gate, even when there is a positive or negative pressure in the housing of the press. A solution is therefore proposed even for dust-tight or containment rotary presses, which are becoming increasingly important due to ever tighter restrictions. The disadvantages associated with more powerful gate drives, such as possible damage to the pellets when switching the gate, increased costs, greater installation space, higher energy demand and greater heat production, are avoided.

Of course, the discharge apparatus may also comprise more than one inlet channel. In the event of multiple inlet channels, it is possible, for example, for only one of them to lead to the gate. For example, another inlet channel may lead directly to an outlet of the rotary press or to an additional gate. As is known, the ejection apparatus of the rotary press may comprise a discarding apparatus, by means of which pellets produced in the rotary press are discarded before they reach the inlet channel of the discharge apparatus that leads to the gate, for example into another inlet channel. As is known, a discarding apparatus of this kind may for example comprise a discarding nozzle, by means of which pellets identified as bad by a sensor system, for example, are discarded into another inlet channel before they reach the inlet channel connected to the gate. The discharge apparatus may also comprise additional discharge channels. For example, it may comprise a third discharge channel that is downstream of the second discharge channel, for example. An additional gate that can be shifted between two positions and that, depending on its position, leaves the pellets in the second discharge channel or directs them from the second discharge channel into the third discharge channel may for example be arranged upstream of the third discharge channel. In principle, any number of inlet channels and any number of discharge channels may be provided. If multiple gates are provided, a pressure equalization channel may be arranged in parallel with one or more or each of the gates. As already explained above, the discharge channels may lead to outlets of the rotary press, for example to an outlet for good pellets, to an outlet for bad pellets, and to at least one outlet for sample-taking.

According to one embodiment, the gate may comprise a gate element, in particular a gate leaf, that can be pivoted between the first position and the second position. Pellets ejected from the ejection apparatus of the rotary press into the inlet channel are diverted by the gate element, in particular the gate leaf, which may for example be designed as a gate plate, into the first discharge channel or into the second discharge channel depending on the pivot position. The pivot axis of the gate element may extend substantially perpendicularly to the longitudinal extension of the inlet channel or the first and second discharge channel.

In an embodiment, the gate element may form a portion of a wall of the inlet channel and/or of the first and/or second discharge channel. Depending on its position, the gate element may form part of the wall of the first or second discharge channel. According to another embodiment, the pressure equalization channel may be directly connected to the first discharge channel and/or the second discharge channel. In an embodiment, the pressure equalization channel may be directly connected to the inlet channel. However, it is also conceivable for the pressure equalization channel to be indirectly connected to the inlet channel, for example via a rotor or pressing chamber of the rotary press.

The invention also achieves the object by means of a rotary press of the above-cited type, wherein a discharge apparatus according to the invention is also provided, and wherein pellets produced in the rotary press are directed by the ejection apparatus into the inlet channel of the discharge apparatus.

An embodiment of a rotary press according to the invention may in principle be configured in a manner known per se. In an embodiment, the rotary press comprises a so-called die plate having a plurality of receiving means in which the material to be pressed, which is generally in powder form, is pressed. The receiving means may be in the form of die plate holes with which the press punches cooperate directly. However, it is also possible for so-called die bushings to be arranged in die plate holes as the receiving means. The die plate may be configured as one single piece or consist of die segments. The rotor is driven by a rotary drive so as to rotate about a vertical axis, for example. The pellets produced using the rotary press may be tablets. The rotary press is equipped with a discharge apparatus according to the invention.

According to one embodiment, the pellets may be conveyed out of the receiving means and onto the die plate before reaching the ejection apparatus by means of the lower press punches. The lower press punches are moved axially upward before reaching the ejection apparatus by means of lower punch guides and, if applicable, control elements, such as cam elements, such that they push the pellets located in the receiving means upward onto the top side of the die plate.

In an embodiment, the ejection apparatus may comprise a scraping apparatus for scraping pellets off the die plate and into the inlet channel of the discharge apparatus. The scraping apparatus may for example comprise a stationary, for example crescent-shaped, scraping element below which the die plate rotates. Pellets conveyed onto the die plate are then scraped into the inlet channel by means of the scraping element.

According to another embodiment, the rotary press may comprise a housing that encloses the rotor and the discharge apparatus. The interior of the housing may be at a positive or negative pressure with respect to the surroundings of the housing or the discharge channels. By generating a corresponding negative pressure, egress of dust from inside the rotary press is minimized. A negative pressure of this kind is present in so-called containment presses, in particular. However, a positive or negative pressure may also be desirable in the case of non-containment presses, for example if a positive or negative pressure is required for suctioning away excess product.

According to another embodiment, the housing may be sealed with respect to the surroundings. The rotary press may therefore be a containment press. Sealing the housing with respect to the surroundings reduces the egress of dust. The rotary press may for example be contained or high-contained according to the SMEPAC standard. It may for example meet at least OEB Level 3. But it may also meet OEB Level 4 or 5, for example.

### BRIEF DESCRIPTION OF THE DRAWINGS

Exemplary embodiments of the invention are explained in greater detail below based on figures, in which:

FIG. 1 illustrates a partial schematic depiction of an embodiment of a rotary press;

FIG. 2 illustrates an enlarged schematic depiction of an embodiment of a discharge apparatus of the rotary press of FIG. 1 in a first operating position;

FIG. 3 illustrates a schematic depiction of the embodiment of the discharge apparatus from FIG. 2 in a second operating position;

FIG. 4 illustrates a schematic depiction of another embodiment of a discharge apparatus of the rotary press shown in FIG. 1; and

FIG. 5 illustrates a schematic depiction of another embodiment of a discharge apparatus of the rotary press shown in FIG. 1.

The same reference numbers refer to the same objects in the figures unless indicated otherwise.

### DETAILED DESCRIPTION OF THE INVENTION

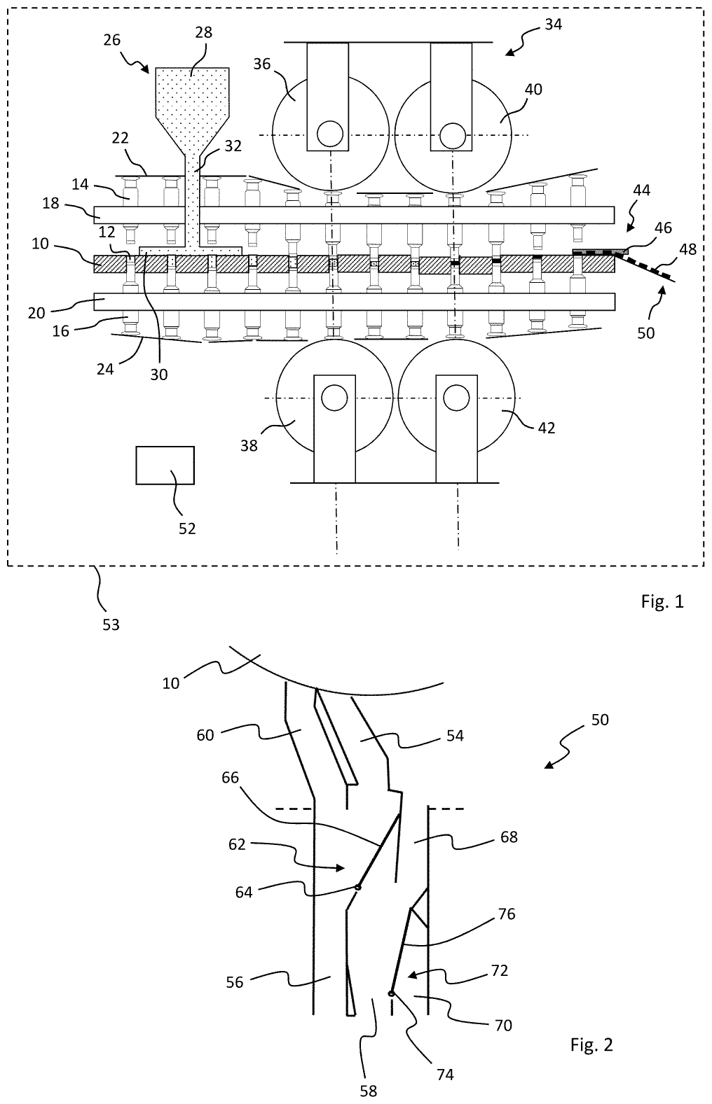

The rotary press, in particular rotary tablet press, shown in FIG. 1 comprises a rotor that is rotationally driven by a rotary drive and that has a die plate 10 comprising a plurality of receiving means 12. The receiving means 12 may for example be in the form of holes in the die plate 10. Furthermore, the rotor comprises a plurality of upper punches 14 and lower punches 16 that rotate synchronously with the die plate 10. The upper punches 14 are axially guided in an upper punch guide 18 and the lower punches 16 are axially guided in a lower punch guide 20. The axial movement of the upper punches 14 and lower punches 16 during the rotation of the rotor is controlled by upper control cam elements 22 and lower control cam elements 24. The rotary press further comprises a filling apparatus 26, which comprises a filling reservoir 28 and a filling chamber 30, which are connected via a feed section 32. In this way, the powdered filling material in the present example passes under the force of gravity from the filling reservoir 28 via the feed section 32 into the filling chamber 30, and passes therefrom via a filling opening provided in the bottom side of the filling chamber 30 into the receiving means 12 of the die plate 10, again under the force of gravity.

The rotary press further comprises a pressing apparatus 34. The pressing apparatus 34 has a pre-pressing apparatus having an upper pre-pressing roller 36 and a lower pre-pressing roller 38, as well as a main pressing apparatus having an upper main pressing roller 40 and a lower main pressing roller 42. Furthermore, the rotary press comprises an ejection apparatus 44 and a scraping apparatus 46 of the ejection apparatus 44 having a scraping element, which feeds the pellets 48, in particular tablets, produced in the rotary press to a discharge apparatus 50 for discharging the pellets from the rotary press. The scraping apparatus 46 may for example comprise a preferably crescent-shaped scraping element 46, which scrapes pellets 48 conveyed by means of the lower punches 16 onto the top side of the die plate 10 off the die plate 10 in the region of the ejection apparatus 44 and feeds them to the discharge apparatus 50.

The rotary press also comprises a control apparatus 52 for controlling its operation. The control apparatus 52 is connected by lines (not shown) to, inter alia, the rotary drive of the rotor and controls the rotary press during operation. It may also be connected to any sensors of the rotary press, in particular receive any sensor data and use same as the basis for the control process. For the control process, the control apparatus 52 may be connected by corresponding lines to all components of the rotary press to be controlled.

Furthermore, the rotary press is arranged in a housing 53 shown as a dashed line in FIG. 1. In particular, the rotor and the discharge apparatus 50 of the rotary press are arranged in the housing 53. The housing 53 may be at a positive or negative pressure with respect to the surroundings of the housing 53 or with respect to the discharge channels 56, 58. Moreover, the housing 53 may be sealed with respect to the surroundings. The rotary press may be a so-called containment press.

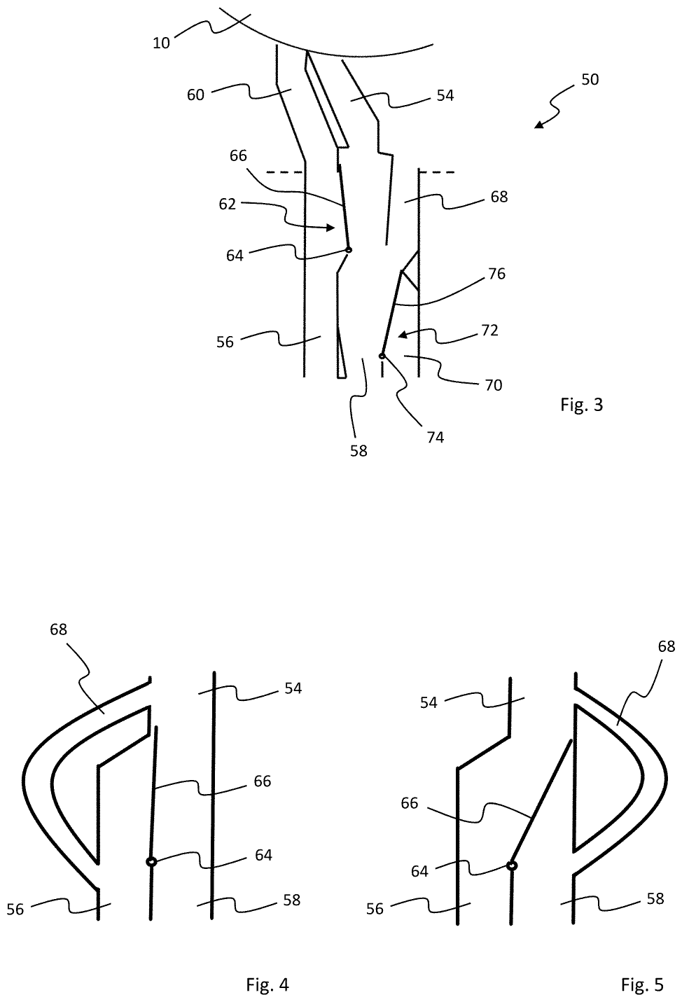

The discharge apparatus 50 of the rotary press will now be explained in greater detail based on FIGS. 2 and 3. The discharge apparatus 50 comprises an inlet channel 54, to which pellets 48 scraped off the die plate 10 by means of the scraping apparatus 46 are generally fed. The discharge channel 50 additionally comprises a first discharge channel 56 and a second discharge channel 58. The first discharge channel 56 leads to a first outlet for pellets produced in the rotary press and the second discharge channel 58 leads to a second outlet for pellets produced in the rotary press. The first outlet, which is connected to the first discharge channel 56, may for example be an outlet for bad pellets, which were identified as flawed by a sensor system of the rotary press, for example. The second outlet, which is connected to the second discharge channel 58, may for example be an outlet for good pellets, which meet the predefined specifications. The discharge apparatus 50 also comprises an additional inlet channel 60, which is directly connected to the first discharge channel 56 and thus to the first outlet of the rotary press, for example for bad pellets. The scraping apparatus 46 may comprise a discarding apparatus, for example comprising a discarding nozzle, by means of which pellets identified as bad are discarded into the additional inlet channel 60 before they reach the inlet channel 54, such that they pass through the first discharge channel 56 and into the first outlet of the rotary press, for example for bad pellets. In principle, the discharge apparatus 50 may comprise a slope, such that the pellets conveyed into one of the inlet channels 54, 60 are conveyed through said apparatus by the force of gravity.

Furthermore, a gate 62 comprising a gate element 66 that can be pivoted about a pivot axis 64 between a first position shown in FIG. 2 and a second position shown in FIG. 3 is located between the inlet channel 54 and the first and second discharge channel 56, 58. The gate element 66 may for example be configured as a so-called gate leaf, for example in the form of a gate plate. In the first position, shown in FIG. 2, pellets conveyed into the inlet channel 54 are fed to the first discharge channel 56 and thus to the first outlet of the rotary press. However, in the second position, shown in FIG. 3, pellets are fed to the second discharge channel 58 and thus to the second outlet of the rotary press. The gate 62 comprises a corresponding pivot drive for moving the gate element 66 between the end positions shown in FIGS. 2 and 3. The gate element 66 thereby forms a portion of a wall of the inlet channel 54 and, depending on its position, of the first and/or second discharge channel 56, 58. Furthermore, a pressure equalization channel 68 that is permanently open in the example shown is arranged in parallel with the gate 62, by means of which channel the pressure is equalized between the inlet channel 54 on the one hand and the first and/or second discharge channel 56, 58 on the other. The pressure is also equalized between the additional inlet channel 60 and the first and/or second discharge channel 56, 58. In particular, the pressure equalization channel 68 is connected indirectly to the inlet channels 54, 60 via the rotor or press interior of the rotary press. However, the pressure equalization channel 68 is on the other hand connected directly to the second discharge channel 58. An airflow can take place by means of the pressure equalization channel 68, in particular when the gate element 66 is moved between the positions shown in FIGS. 2 and 3, which airflow reduces a pressure difference across the gate 62 at least to the extent that the gate element 66 safely and reliably reaches its relevant end position without larger drives being required.

In the example shown, the discharge apparatus 50 also comprises a third discharge channel 70, which leads to a third outlet of the rotary press for pellets, in particular an outlet for sampling, i.e. for pellets to be supplied for random testing. In the example shown, an additional gate 72, also comprising a gate element 76, again a gate leaf, for example, that can pivot about a pivot axis 74, is located between the second discharge channel 58 and the third discharge channel 70. This additional gate 72 is shown in both its positions/end positions in FIGS. 2 and 3. In this position, pellets directed into the second discharge channel 58 remain therein and arrive at the second outlet of the rotary press. By switching the second gate 72 into its second position, in which its free end adjoins the intermediate wall between the first and second discharge channel 56, 58, pellets directed into the second discharge channel 58 can be directed out of this channel and into the third discharge channel 70 and thus to the third outlet of the rotary press.

FIGS. 4 and 5 show other exemplary embodiments of a discharge apparatus according to the invention. In the exemplary embodiment according to FIG. 4, the pressure equalization channel 68 is directly connected to the inlet channel 54 on one side and directly connected to the first discharge channel 56 on the other side. It correspondingly ensures pressure equalization between the inlet channel 54 and the first discharge channel 56. In the exemplary embodiment shown in FIG. 5, the pressure equalization channel 68 is directly connected to the inlet channel 54 on one side and directly connected to the second discharge channel 58 on the other side. It correspondingly ensures pressure equalization between the inlet channel 54 and the second discharge channel 58. Otherwise, the discharge apparatuses according to FIGS. 4 and 5 can be designed or integrated into the rotary press in the same way as the exemplary embodiment according to FIGS. 1 to 3 explained above. For example, the discharge apparatuses according to FIGS. 4 and 5 may also comprise an additional gate 72 and a third discharge channel 70, as explained above with reference to FIGS. 1 to 3.

### LIST OF REFERENCE SIGNS

10 Die plate
12 Receiving means
14 Upper punches
16 Lower punches
18 Upper punch guide
20 Lower punch guide
22 Upper control cam elements
24 Lower control cam elements
26 Filling apparatus
28 Filling reservoir
30 Filling chamber
32 Feed section
34 Pressing apparatus
36 Upper pre-pressing roller
38 Lower pre-pressing roller
40 Upper main pressing roller
42 Lower main pressing roller
44 Ejection apparatus
46 Scraping apparatus
48 Pellets
50 Discharge apparatus
52 Control apparatus
53 Housing
54 Inlet channel
56 First discharge channel
58 Second discharge channel
60 Additional inlet channel
62 Gate
64 Pivot axis
66 Gate element
68 Pressure equalization channel
70 Third discharge channel
72 Additional gate
72 Pivot axis
76 Gate element

1. A discharge apparatus for discharging pellets from a rotary press, the discharge apparatus comprising:
an inlet channel configured to receive pellets from an ejection apparatus of the rotary press;
a first discharge channel connected to the inlet channel;
a second discharge channel connected to the inlet channel;
a gate positioned between the inlet channel and the first and second discharge channels, wherein the gate is configured to be shifted between a first position, in which pellets are directed from the inlet channel into the first discharge channel, and a second position, in which pellets are directed from the inlet channel into the second discharge channel; and
a pressure equalization channel configured to open into one of the first and second discharge channels, wherein the pressure equalization channel is configured to equalize a pressure between the inlet channel and at least one of the first and second discharge channels.

2. The discharge apparatus according to claim 1, wherein a flow cross-section of the pressure equalization channel is at least 10% of a flow cross-section of the inlet channel.

3. The discharge apparatus according to claim 1, wherein a flow cross-section of the pressure equalization channel is at least 100% of a flow cross-section of the inlet channel.

4. The discharge apparatus according to claim 1, wherein the gate comprises a gate element configured to be pivoted between the first position and the second position.

5. The discharge apparatus according to claim 4, wherein the gate element is a gate leaf.

6. The discharge apparatus according to claim 4, wherein the gate element forms a portion of a wall of at least one of: (1) the inlet channel; (2) the first discharge channel; and (3) the second discharge channel.

7. The discharge apparatus according to claim 1, wherein the pressure equalization channel is directly connected to the inlet channel.

8. The discharge apparatus according to claim 1, wherein the pressure equalization channel is configured to be connected to the inlet channel via one or more interior spaces of the rotary press.

9. A rotary press comprising:
a rotor comprising an upper punch guide and a lower punch guide;
upper press punches configured to be guided by the upper punch guide;
lower punches configured to be guided by the lower punch guide;
a die plate positioned between the upper and lower punch guides and defining a plurality of openings, wherein the upper press punches and the lower press punches cooperate with the plurality of openings of the die plate;
at least one filling apparatus configured to dispense filling material into the plurality of openings;
at least one pressing apparatus configured to cooperate with the upper press punches and lower press punches during operation to press the filling material in the plurality of openings into pellets;
an ejection apparatus configured to eject the pellets from the plurality of openings; and
a discharge apparatus configured to discharge the pellets from the rotary press, the discharge apparatus comprising,
an inlet channel configured to receive pellets from the ejection apparatus,
a first discharge channel connected to the inlet channel,
a second discharge channel connected to the inlet channel,
a gate positioned between the inlet channel and the first and second discharge channels, wherein the gate is configured to be shifted between a first position, in which pellets are directed from the inlet channel into the first discharge channel, and a second position, in which pellets are directed from the inlet channel into the second discharge channel, and
a pressure equalization channel configured to equalize a pressure between the inlet channel and at least one of the first and second discharge channels.

10. The rotary press according to claim 9, wherein the pellets are removed from the plurality of openings and deposited onto the die plate by the lower punches before the pellets reach the ejection apparatus.

11. The rotary press according to claim 9, wherein the ejection apparatus comprises a scraping apparatus configured to scrape the pellets off the die plate and into the inlet channel of the discharge apparatus.

12. The rotary press according to claim 9, further comprising a housing configured to enclose the rotor and the discharge apparatus.

13. The rotary press according to claim 12, wherein an interior of the housing is at a pressure that is different than a pressure within the discharge apparatus.

14. The rotary press according to claim 13, wherein the housing is sealed from an external environment.
